(19) United States
(12) Patent Application Publication
(10) Pub. No.: US 2026/0183983 A1
(43) Pub. Date: Jul. 2, 2026

(54) APPARATUS FOR CUTTING FOOD PRODUCTS, APPARATUS FOR PROCESSING FOOD PRODUCTS, AND A FASTENING MECHANISM

(71) Applicant: Nordischer Maschinenbau Rud. Baader GmbH + Co. KG, Lübeck (DE)

(72) Inventor: Gunnar Krepinsky, Lübeck (DE)

(21) Appl. No.: 19/131,431

(22) PCT Filed: Oct. 9, 2023
(86) PCT No.: PCT/EP2023/077827

§ 371 Date: May 20, 2025

(30) Foreign Application Priority Data
Nov. 23, 2022 (EP) 22209139.9

(51) Int. Cl. B26D 7/26; A22C 17/00; B26D 1/00; B26D 1/143; B26D 7/06

(52) U.S. Cl. CPC B26D 7/2614; A22C 17/0006; B26D 1/0006; B26D 1/143; B26D 7/06; B26D 2001/0033; B26D 2210/02

(57) ABSTRACT

An apparatus for cutting food products including at least one blade device for undoable arrangement of a blade element, at least one rotatably mounted blade shaft that is configured and adapted to receive the blade device, and at least one drive element that is configured and adapted to drive the blade shaft in a direction of rotation. The blade device includes a fastening mechanism for undoably fastening a blade element on the blade shaft. The fastening mechanism is configured and adapted as a quick-release blade lock.

### CROSS-REFERENCE TO RELATED APPLICATIONS

The present application is the National Phase entry of International Patent Application No. PCT/EP2023/077827 filed Oct. 9, 2023, which claims priority to European Patent Application No. 22209139.9 filed Nov. 23, 2022, the entire contents of both are hereby incorporated by reference into this application.

### TECHNICAL FIELD

The present disclosure relates to an apparatus for cutting food products comprising at least one blade device for undoable arrangement of a blade element, at least one rotatably mounted blade shaft that is configured and adapted to receive the blade device, and at least one drive element that is configured and adapted to drive the blade shaft in a direction of rotation.

The present disclosure furthermore relates to an apparatus for processing food products, in particular for processing carcasses, comprising a conveying unit configured and adapted to convey the food products in a conveying direction T along a conveying path through at least one dressing station for processing the carcasses, namely an apparatus for detaching and/or cutting meat or carcass components from a carcass or parts thereof.

The present disclosure further relates to a fastening mechanism for undoably fastening a blade element to a blade shaft.

### BACKGROUND

Apparatuses for cutting or processing food products have been known from the prior art for many years. Such apparatuses are used in numerous different branches of industry and are always required when food products have to be chopped, severed, trimmed, divided etc. In the context of automatic or automatable processing of food products, blade devices with circular blades, for example used in the meat processing industry, are particularly common. Such food products can, for example, be provided for processing away from the carcass region, wherein industrially processable carcasses such as fish or poultry are common.

When such apparatuses are in industrial service for cutting or processing food products, it is regularly necessary to swap or change the blade elements, inter alia also known as cutting means or cutting elements, that are arrangeable on the blade device. Swapping blade elements is necessary, for example, to sharpen or replace them or to change to a blade element appropriate for a particular purpose. In conventional apparatuses, the blade elements are secured to the blade shaft with blade nuts. Securing the blade elements with blade nuts is an inexpensive and simple way of arranging a blade element on a blade device. The arrangement is, however, error-prone, time-consuming and involves a considerable risk of injury when blade elements are being changed.

In conventional apparatuses, the blade elements are fastened to the blade device using a threaded solution with an appropriate outer contour. For this purpose, the blade shaft or blade device often has a screw or threaded bolt for arranging a counterpart with an internal thread for fastening. Such counterparts are frequently configured as nuts (blade nuts) or the like that are provided with a wrench for fastening the corresponding blade element. A circular movement along the cutting edge of the blade element has to be made with the wrench in order to undo or fasten the blade nuts. This involves a safety risk, especially during initial undoing or final fastening because it is at these points that there is an increased risk of slipping and significant force is required. There is particular potential for risk if the blade nuts have to be undone using an abrupt application of force, for example with a jerk. In addition, using wrenches can damage the blade device due to excessive application of force by the wrench. If, however, the blade nut is not adequately fastened, this can lead to the blade element undesirably coming undone during intended use of the apparatus. In addition, frequent undoing and fastening can damage the internal or external thread of the screw connection, resulting on the one hand in inadequate fastening or a need to replace the components concerned, which leads to undesirable and unplannable time and costs.

Overall, changing the blade elements with known fastening mechanisms, especially in places that are difficult to access, is tedious and troublesome and associated with considerable potential risk. In addition, known apparatuses are often provided with blade devices arranged in pairs, each of which has an independent blade element (circular blade). In the case of blade elements arranged in pairs, the threads on the different sides generally each have a different direction of rotation which entails specific blade nuts that generally have a left-hand or right-hand thread. During intended use of the apparatuses, this leads to delays in refitting as various screw nuts have to be kept in stock.

It is therefore an object of the present disclosure to provide an apparatus for cutting food products which ensures reliable fastening of blade elements and is at the same time quick and convenient to operate, and which also offers a low risk of injury during operation. A further object is to provide a corresponding apparatus for processing food products.

### SUMMARY

This object is achieved by the above-stated apparatus for cutting food products in that the blade device comprises a fastening mechanism for undoably fastening a blade element to the blade shaft, wherein the fastening mechanism is configured and adapted as a quick-release blade lock. The apparatus according to the present disclosure ensures that simple, rapid and safe fastening of a blade element to a blade device is guaranteed. The fastening mechanism configured and adapted as a quick-release blade lock in particular enables changing blade elements without making a rotational movement of the hands, so minimising the risk of injury to the user. In this way, no movement is required along the course of the cutting edge of the blade and the focus of the working area when blade elements are being changed is on the centred region of the blade device. In embodiments, the quick-release blade lock according to the present disclosure is further distinguished in that tool-free use is provided. In embodiments, the quick-release blade lock can be manually actuated, so simplifying handling and ensuring a small space requirement with regard to the movement radius when the blade elements are being changed. In addition to simple and rapid fitting or operation of the quick-release blade lock, reliable fixation of the blade elements to the blade shaft is provided in order to ensure proper use for dressing food products. The quick-release blade lock allows counterclockwise and clockwise rotation of the blade element without a blade nut having to be loosened or undone. The quick-release blade lock provides constant and consistent fixation during the entire period of use. The design of the quick-release blade lock according to the present disclosure can in principle be flexibly configured and adapted, wherein, however, undoable fastening of a blade element to the blade shaft is providable in each case. In embodiments, the quick-release blade lock is designed for one-handed and tool-free use. In embodiments, the quick-release blade lock provides a threadless connection between the quick-release blade lock and the base member or blade shaft. The blade shaft is at least rotatably mounted, wherein the blade shaft is, however, in embodiments, configured and adapted to be axially displaceable. In embodiments, apparatuses for cutting food products comprise at least one pair of blade devices consisting of two blade devices, arranged opposite one another, on each of which is arranged one blade element. The material or materials of the blade device is/are of no relevance to the present disclosure, wherein the material selected is sufficiently hard, durable and hygienic to ensure reliable use in the food processing industry. In embodiments, the blade device, in particular the blade shaft and/or the quick-release blade lock, is made of metal, particularly stainless steel. It is alternatively possible for the blade device or individual components thereof to be selected from a plastics material, for example ABS, PA, PE, POM, PP, PVC etc., in particular from a hard and food-safe plastics material.

Overall, the quick-release blade lock is provided to form the undoable connection between the rotatable or rotatably driven blade shaft and the blade element. The quick-release blade lock constitutes a coupling device for couplably arranging the blade element on the blade device. Locking of the coupling device can be undone by manually undoing the connection between the blade shaft and the blade element or correspondingly making the connection.

In embodiments, the blade device comprises a blade base member, wherein the blade base member is configured and adapted to be undoably arrangeable by the quick-release blade lock in at least one recess having the blade shaft in order to undoably fix at least one blade element. This ensures safe and simple arrangement of the blade element by the blade device. In embodiments, the blade base member forms a counterpart to the recess of the blade shaft in order to provide at least one form-fit arrangement. The shape of the blade base member can be adapted depending on the intended purpose or type of blade element and for example have a round, oval or rectangular cross-section, in embodiments, the cross-section is rotationally symmetrical. In embodiments, the blade base member is a region that can be brought at least in part into contact with the blade shaft, the quick-release blade lock and/or the blade element. On actuation of the quick-release blade lock, the blade base member is fixable in or undoable from the recess of the blade shaft in order to provide an arrangement of the blade element or to configure and adapt removal of the blade element. In embodiments, the blade shaft may at least in portions be a component of the blade device, in embodiments, the blade shaft can comprise at least a portion of the blade base member.

A further development is distinguished in that the quick-release blade lock is configured and adapted to be modifiable at least between an open position and a closed position, wherein, in the closed position, the quick-release blade lock fixes the blade element against spontaneously coming undone. In order to modify the positions, at least one component of the quick-release blade lock is configured and adapted to be positionally modifiable. In embodiments, the positionally modifiable component is configured and adapted to be movable in order to provide fixing or undoing of the blade element. In embodiments, a visual and/or acoustic indication is configured and adapted in the event of a change in position from the open position into the closed position. In this way, reliable fixation of the manner is identifiable in the case of intended use of the apparatus. In embodiments, the quick-release blade lock is configured and adapted to be arrestable in at least one of the positions in order in each case to prevent a spontaneous change in position. In embodiments, the quick-release blade lock is configured and adapted to be pivotable or slidable, wherein the modification of positions is providable in the event of a pivoting movement or a sliding movement.

In embodiments, the recess of the blade shaft has at least one engagement recess and the blade base member comprises at least one engagement element for engaging with the engagement recess, wherein, in the closed position of the quick-release blade lock, the engagement element is configured and adapted to be in force-fit and/or form-fit engagement with the at least one engagement recess and wherein, in the open position of the quick-release blade lock, the at least one engagement element is configured and adapted to be substantially out of engagement with the at least one engagement recess. The combination of the at least one engagement recess in conjunction with the at least one engagement element enables improved fixation of the blade element by the force- and/or form-fit engagement, so ensuring a reliable arrangement on the apparatus according to the present disclosure. The engagement of the at least one engagement element in the at least one engagement recess is configured and adapted to be force- and/or form-fitting in order to ensure that the blade element is held captive against as many forces that occur as possible. In embodiments, a plurality of engagement elements are provided which may be configured to be modifiable in positioning by the quick-release blade lock for engagement with the at least one engagement recess. It is not immediately necessary for the purposes of the present disclosure for return of the at least one engagement element out of the at least one engagement recess to be providable on changeover of the quick-release blade lock from the closed position into the open position. In embodiments, in the event of modification of the quick-release blade lock from the closed position into the open position, at least one engagement element is released such that the force- and/or form-fit engagement is disengageable. The configuration of the at least one engagement element is of no relevance to the present disclosure and the body of the at least one engagement element may in principle be of any shape that is arrangeable in an engagement recess. However, when selecting the appropriate engagement element, consideration must in particular be given to possible jamming or distortion and possible material costs. In embodiments, the shape of the at least one engagement element is selected from spheres, studs, cones, cylinders and/or cubes, wherein the at least one engagement recess must in each case be correspondingly shaped at least in part in order to provide a reliable arrangement and force- and/or form-fit connection between the components. In embodiments, a spherical configuration of the at least one engagement element is particularly appropriate as it provides a centring action in the at least one engagement recess.

A further development is distinguished in that the quick-release blade lock comprises at least one arresting element and at least one transfer element, wherein the at least one arresting element is configured and adapted for modifying the position of the quick-release blade lock at least between the open position and the closed position by the at least one arresting element being in operative connection with the at least one transfer element in such a way that it configures and adapts a modification in position of the at least one transfer element. Thanks to the interaction of the least one arresting element and the at least one transfer element, it is possible to produce a direct transfer and change in state of the quick-release blade lock between the open and the closed position in order to configure and adapt fixing or undoing of the blade element. In embodiments, the at least one arresting element is operable one-handedly. In embodiments, the at least one arresting element can exert a force on and/or by the at least one transfer element. Thanks to the at least one arresting element and/or the at least one transfer element, modifiability of the at least one engagement element with the at least one engagement recess is directly or indirectly providable.

In embodiments, the at least one transfer element can be brought into operative connection with the least one engagement element in such a way that, in the event of a modification in position, the at least one transfer element configures and adapts a force-fit and/or form-fit engagement of the at least one engagement element in the at least one engagement recess or that the at least one transfer element enables release of the at least one engagement element from the at least one engagement recess, wherein in particular, in an open position of the quick-release blade lock, release of the at least one engagement element out of at least one engagement recess is provided and, in a closed position of the quick-release blade lock, engagement of the at least one engagement element with the at least one engagement recess is provided. In embodiments, the at least one transfer element can be brought into operative connection with at least one engagement element by the at least one transfer element being axially displaced on actuation of the arresting element in order to configure and adapt modifiability of the position of the at least one engagement element. In embodiments, on changeover of the quick-release blade lock into the closed position, the at least one engagement element engages at least in part in the at least one engagement recess. In embodiments, in the closed position of the quick-release blade lock, the at least one engagement element transfers force between the blade shaft and blade base member, so fixing the blade element to the blade shaft.

A convenient configuration of the present disclosure is that the at least one engagement recess is configured and adapted, in particular circumferentially configured and adapted, on the inner wall of the recess of the blade shaft. Alternatively, a plurality of engagement recesses can be configured and adapted, into each of which at least one engagement element is engageable. A circumferential engagement recess enables flexible engagement with at least one engagement element since there is no need for a specific assignment between engagement element and engagement recess. In embodiments, the circumferential recess is in particular configured and adapted as a groove, particularly as an annular groove.

A further convenient configuration of the present disclosure is that at least two to seven engagement elements, particularly three to five engagement elements, are provided. In embodiments, the engagement elements are arranged in a star shape and/or symmetrically along the blade base member. On the one hand, this ensures uniform force uptake and transfer and, on the other hand, it assists a centring and fixing arrangement of the quick-release blade lock on the blade shaft. In embodiments, the number of engagement recesses corresponds to the number of engagement elements. Alternatively, a smaller number of engagement recesses may be present which correspondingly configure and adapt engagement of a plurality of engagement elements.

A further development of the present disclosure is distinguished in that the at least one engagement element and the at least one engagement recess are configured and adapted to correspond to one another at least in portions, in particular such that, in the closed position of the quick-release blade lock, a force-locking and/or form-fit connection is provided between the at least one engagement element and the at least one engagement recess. In other words, the at least one engagement element is configured and adapted to be congruent at least in part with the at least one engagement recess in order to provide a force-locking and/or form-fit connection between the at least one engagement element and the at least one engagement recess. In this way, the quick-release blade lock secures the blade element on the blade shaft in a manner that can be quickly and simply undone if necessary.

A further embodiment of the present disclosure is distinguished in that the at least one engagement element is arrangeable within the blade base member in such a way that it is configured and adapted to be movable but captive. Depending on the configuration of the blade base member and/or the engagement element, further components and/or designs may be provided to hinder the mobility of the at least one engagement element. In embodiments, the at least one engagement element is arrangeable in a recess having the blade base member in order to provide limited mobility. The captive arrangement of the at least one engagement element means that the quick-release blade lock is quick and convenient to operate when the blade elements are being changed. In addition, individual components are prevented from entering the manufacturing process, something which it is desirable to avoid in the food processing industry. In embodiments, the quick-release blade lock is particularly configured and adapted in one piece, i.e. the components present are each connected to one another or are at least captively secured.

A further development is distinguished in that the arresting element is connected, in particular captively connected, to the blade base member. The captive arrangement of the at least one arresting element means that the quick-release blade lock is quick and convenient to operate when the blade elements are being changed. In addition, individual components are prevented from entering the manufacturing process, something which it is desirable to avoid in the food processing industry. In embodiments, the blade base member is particularly configured and adapted in one piece, i.e. the components present are each connected to one another or are at least captively secured to one another.

A further development is that the arresting element is configured and adapted as a sliding element slidable at least between an open position and a closed position, wherein, on displacement of the sliding element, at least a change between the open position and the closed position is configured and adapted. Sliding elements are in particular suitable for one-handed operation, as displaceability and thus the change in position of the arresting element is configured and adapted in this way by linear application of force. A sliding movement means that no rotational movement along the cutting edge of the blade is required, so increasing safety when the blade elements are being changed. In embodiments, the sliding element is displaceable in at least two directions in order in each case to configure and adapt a change between the open position and the closed position.

Another further development is the sliding element comprises at least two sliding recesses that are configured and adapted to engage at least in part with the transfer element, wherein at least one of the sliding recesses configures and adapts a smaller engagement with the transfer element. In embodiments, when the transfer element is spring-loaded, the at least one sliding recess for forming a smaller engagement results in a greater linear movement of the transfer element. The sliding recesses enable a modification of the transfer element each time the sliding element is moved. The sliding recesses specify a region into which the transfer element is engageable, so resulting in axial longitudinal displacement. Thanks to the longitudinal displacement, it is possible to effect modifiability of the position of the at least one engagement element in order to bring the at least one engagement element into engagement with or release it from the at least one engagement recess. In embodiments, in the event of the transfer element engaging with the at least one sliding recess to form a smaller engagement, the at least one engagement element is transferable at least in part into the at least one engagement recess. In embodiments, in the event of the transfer element engaging with the further sliding recess, the at least one engagement element is releasable from the at least one engagement recess. The sliding recess in each case specifies a defined region in order to configure and adapt fixation of the blade element by the quick-release blade lock by application of force.

A convenient configuration of the present disclosure is that the arresting element is configured and adapted as a lever element slidable at least between an open position and a closed position, wherein, on actuation of the lever element, at least a change between the open position and the closed position is configured and adapted. Lever elements are in particular suitable for one-handed operation, as modifiability of the position of the arresting element is configured and adapted by actuation of the lever, in particular by a pivoting movement, a lever movement or a flipping movement. A corresponding movement of the lever element means that no rotational movement along the cutting edge of the blade is required, so increasing safety when the blade elements are being changed. Each time the lever element is actuated, there is a change between the open position and the closed position.

A further convenient configuration of the present disclosure is that the lever element is configured and adapted as an eccentric lever, wherein, in the closed position, an actuating portion of the eccentric lever can be brought into operative connection with the transfer element, and wherein, in the open position, the actuating portion of the eccentric lever releases the transfer element. In this way, thanks to the operative connection with the transfer element, the eccentric lever enables a modification of the at least one engagement element in conjunction with the engagement recess. The at least two positions of the eccentric lever in particular enable active control of the at least one engagement element, in particular when the transfer element is spring-loaded. The position of the transfer element can be modified by actuation of the lever element, in particular from the open position into the closed position. In embodiments, movement of the transfer element is determined by the eccentric mechanism, resulting in axial longitudinal displacement. Thanks to the longitudinal displacement of the transfer element, it is possible to effect modifiability of the position of the at least one engagement element in order to bring the at least one engagement element into engagement with or release it from the at least one engagement recess. In embodiments, when the lever element is transferred from the open position into the closed position, the at least one engagement element is configured and adapted to be engageable at least in part in the at least one engagement recess. In embodiments, when the lever element is transferred from the closed position into the open position, the at least one engagement element is releasable from the at least one engagement recess. The eccentric portion of the lever element in each case specifies a defined region in order to configure and adapt fixation, provided by application of force, of the blade element by the quick-release blade lock, or to configure and adapt the displacement of the transfer element. A further embodiment provides an inverted configuration of the lever element in order to configure and adapt a modification of the transfer element. In particular, the closed and the open position and the resultant modifiability of the position of the engagement element is correspondingly oppositely configured and adapted.

A further development of the present disclosure is distinguished in that the blade device comprises at least one restoring element that is configured and adapted to exert a restoring force on the transfer element that moves the latter into or in the direction of the quick-release blade lock. In embodiments, in the unloaded state, the restoring element releases a clearance space of the blade base member, into which space the at least one engagement element is arrangeable at least in portions. In embodiments, when the transfer element is moved, i.e. against the restoring force, the at least one engagement element is movable at least in portions out of the clearance space of the blade base member in order to configure and adapt engagement with the at least one engagement recess. In other words, the clearance space is a movement space for the at least one engagement element in order to configure and adapt a modification of the position of the at least one engagement element depending on the displacement of the transfer element. In embodiments, the transfer element may be pretensionable against the restoring force in order to prevent a spontaneous movement of the transfer element into the clearance space. In embodiments, the restoring element is a spring element. In embodiments, the restoring element comprises at least one magnetic and/or magnetisable component, particularly two magnets, which are in particular configured and adapted to be of identical polarity to one another.

A further convenient configuration of the present disclosure is that the blade element comprises at least one fixation recess and the blade device comprises at least one fixation element that corresponds at least in portions to the at least one fixation recess, whereby the blade element is fixedly arrangeable on the blade device with a form fit and non-rotatably relative to the blade shaft by the quick-release blade lock. During intended use, the blade element is thus secured against undesirably coming undone and/or rotating, so ensuring precise cutting and safe operation of the apparatus. The combination of fixation element and fixation recess can in particular increase the maximum transfer of force by the at least one blade element and prevent slippage. Alternatively or additionally, the blade element may comprise at least one fixation element, while the blade device comprises at least one fixation recess corresponding to the fixation element, whereby the blade element is arrangeable on the blade device in fixed manner with a form fit and non-rotatably relative to the blade shaft by the quick-release blade lock. In embodiments, the blade base member has the at least one fixation element and/or the at least one fixation recess. Such fixation elements are known, for example, by the designation drive studs, wherein pins, convexities etc. can likewise be provided. Such fixation elements enable driving or centring and positioning of the blade element. In principle, any combination of fixation element and fixation recess that enables at least a form-fit between the blade element and quick-release blade lock is possible.

In a further embodiment, at least one spacer element is arrangeable on the blade device, which spacer element is arrangeable under and/or on the blade element and is undoably fixable by the quick-release blade lock. Such spacer elements are in particular configured and adapted for simple adjustment of the position of the blade elements. Such spacer elements are known, for example, by the designation spacer washers. If fixation elements and/or fixation recesses are provided on the blade device, corresponding fixation elements and/or fixation recesses must likewise in each case be provided on the spacer elements.

The object is also achieved by the further above-stated apparatus for processing food products, in particular for processing carcasses, in that the apparatus for detaching and/or cutting is configured and adapted downstream of the apparatus for cutting food products or of a further development thereof. For the avoidance of repetition, reference is also in particular made in connection with the further apparatus according to the present disclosure to the aspects already described in detail in connection with the apparatus for cutting food products. These apply analogously. In embodiments, the carcasses are fish, in particular slaughtered fish or poultry carcasses with an opened and eviscerated abdominal cavity.

The object is furthermore achieved by the above-stated fastening mechanism in that the latter is configured and adapted as a quick-release blade lock according to the present disclosure. For the avoidance of repetition, reference is also in particular made in connection with the fastening mechanism according to the present disclosure to the aspects already described in detail in connection with the apparatus according to the present disclosure. These also apply analogously to the fastening mechanism according to the present disclosure.

### BRIEF DESCRIPTION OF THE DRAWINGS

Further convenient and/or advantageous features and further developments and apparatus-related subjects are revealed by the claim and the description. Particularly embodiments of the apparatus according to the present disclosure and of the fastening mechanism according to the present disclosure are explained in greater detail with reference to the appended drawings, in which:

FIG. 1 is a schematic diagram of a first embodiment of a subportion of an apparatus according to the present disclosure with a fastening mechanism in perspective view,

FIG. 2 is a schematic diagram of a region of the first embodiment of an apparatus according to the present disclosure in perspective view,

FIG. 3 is a schematic diagram of a region of the first embodiment of an apparatus according to the present disclosure in cross-section,

FIG. 4 is a further schematic diagram of a region of the first embodiment of the apparatus according to the present disclosure in cross-section,

FIG. 5 is a schematic diagram of a region of a second embodiment of an apparatus according to the present disclosure with a fastening mechanism in perspective view,

FIG. 6 is a schematic diagram of a region of the second embodiment of the apparatus according to the present disclosure in cross-section and

FIG. 7 is a further schematic diagram of a region of the second embodiment of the apparatus according to the present disclosure in cross-section.

### DETAILED DESCRIPTION

The above-stated figures describe the apparatuses according to the present disclosure and the fastening mechanism according to the present disclosure in greater detail.

The apparatuses 10 shown in the drawings are configured and adapted by way of example for cutting animal products, in particular fish. The apparatuses 10 are, however, in principle equally suitable for cutting other food products 11 (bread, cheese, vegetables, fruit etc.), wherein appropriate modifications may optionally have to be made to the arrangement and/or positioning, dimensioning or orientation of individual components. The apparatuses 10 are furthermore configured and adapted by way of example as a self-contained and separate apparatus 10. However, the present disclosure relates in the same way to a comparable apparatus 10 that is integrated in a more complex system with a plurality of assemblies or further upstream and/or downstream apparatuses or machine components. Such apparatuses 10 may in particular be variably configured and adapted in (machine) width and/or length, such that a plurality of food products 11 can be processed in parallel or in series by the apparatus 10. In other words, a plurality or multiplicity of food products 11 can be processed in parallel on an apparatus 10 by appropriately adapting the width and/or length of the components of the apparatus. The provided devices and respective elements must to this end be adapted accordingly in order to provide widthwise scalability.

In embodiments, the provided food products 11 are dressed and/or processed by a system that may comprise an apparatus 10 according to the present disclosure and/or downstream of which is arranged an apparatus 10 according to the present disclosure. Such a system (not shown in the figures) comprises different system components for dressing and/or processing the corresponding food products 11 with the intended properties.

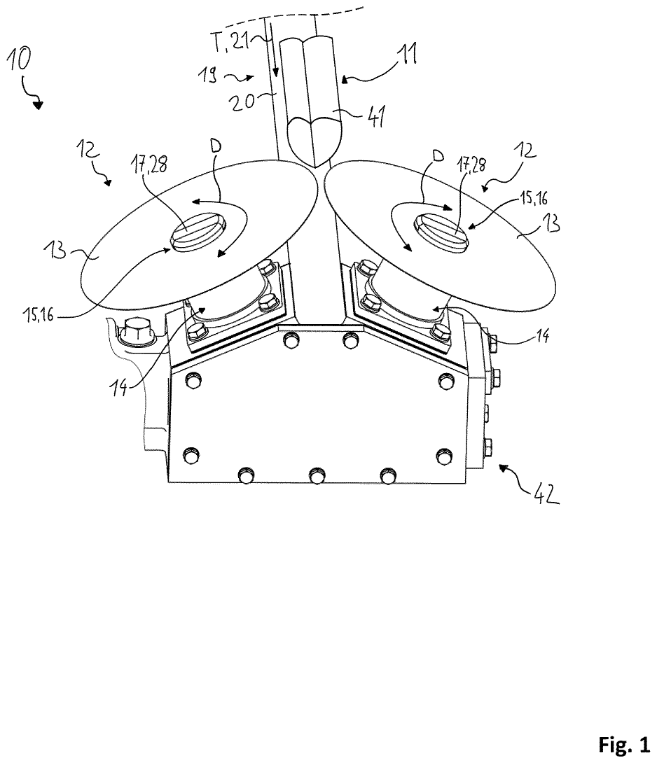

FIG. 1 to FIG. 4 and FIG. 5 to FIG. 7 show different embodiments of an apparatus 10 according to the present disclosure or components thereof. The apparatus 10 according to the present disclosure is configured and adapted for cutting food products 11 and comprises at least one blade device 12 for undoable arrangement of a blade element 13, at least one rotatably mounted blade shaft 14 that is configured and adapted for accommodating the blade device 12 and at least one drive element (not shown in detail in the figures) that is configured and adapted to drive the blade shaft 14 in a direction of rotation D. As shown in FIG. 1, such apparatuses 10 often have at least two blade elements 13, in particular at least two complete blade devices 12, each of which is configured and adapted for independently cutting food products 11.

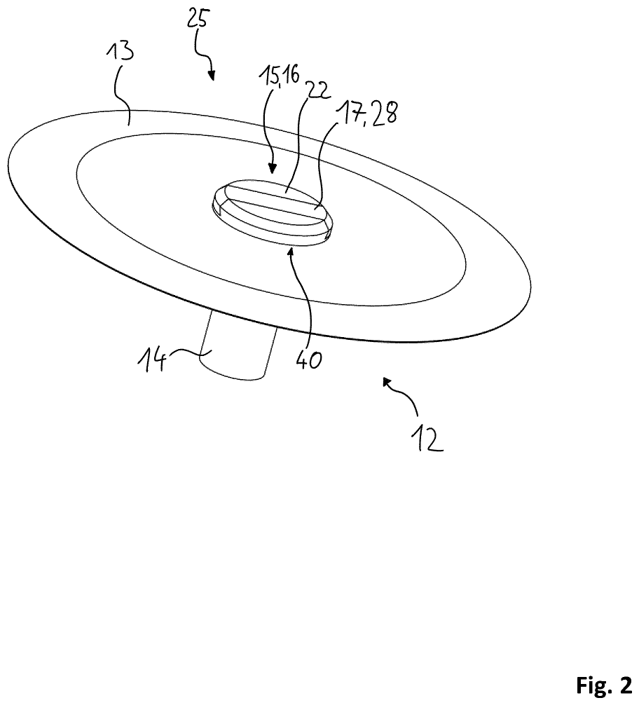

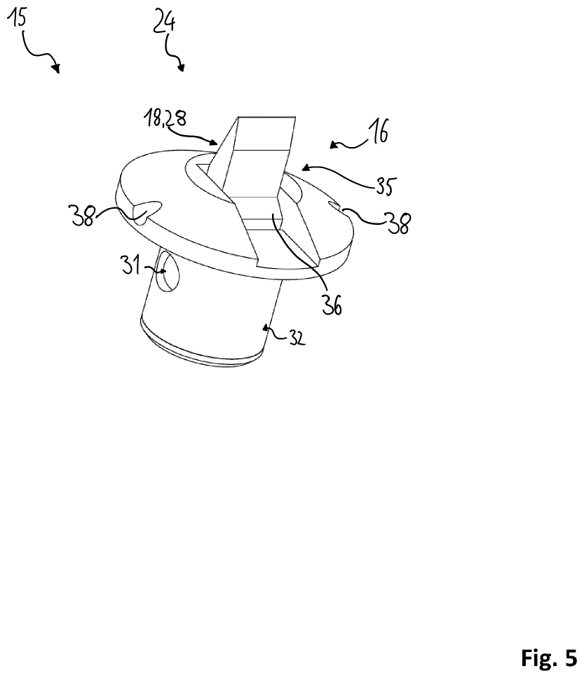

The apparatus 10 is distinguished according to the present disclosure in that the blade device 12 comprises a fastening mechanism 15 for undoably fastening a blade element 13 to the blade shaft 14, wherein the fastening mechanism 15 is configured and adapted as a quick-release blade lock 16. FIG. 2 to FIG. 4 show exemplary portions or detail views of a first embodiment of a corresponding fastening mechanism 15 or of an apparatus 10 that is configured and adapted as a quick-release blade lock 16, or comprises a quick-release blade lock 16. The first embodiment of the quick-release blade lock 16 is characterised by a sliding element 17. FIG. 5 to FIG. 7 show a further embodiment of a corresponding fastening mechanism 15 that is likewise configured and adapted as a quick-release blade lock 16 and has a lever element 18. Such quick-release blade locks 16 are in principle configured and adapted for arranging at least one blade element 13 on a blade device 12. The quick-release blade locks 16 ensure reliable and rapid replaceability of the corresponding blade elements 13. In embodiments, such quick-release blade locks 16 require no (special) tools to ensure operability. In embodiments, manual operation of the quick-release blade locks 16 is provided by the sliding element 17 being displaced or the lever element 18 being flipped up or down as appropriate.

As shown in FIG. 1, in embodiments of the apparatuses 10 according to the present disclosure, at least one conveying device 19 with at least one conveying element 20 is provided for conveying or feeding the food products 11 in order to convey the food products 11 in a conveying direction T along a conveying route 21. The food products 11 are supplied in this manner to the blade device 12 in order to configure and adapt appropriate cutting by the at least one blade element 13. In embodiments, additional retaining elements may be provided in order to configure and adapt retention and/or positioning of the food products 11. FIG. 2 to FIG. 7 in each case show detailed portions of two different embodiments of the apparatus 10 according to the present disclosure, with detailed views or individual components of the blade device 12 being shown in each case.

FIG. 1 to FIG. 7 show that the blade device 12 comprises a blade base member 22, wherein the blade base member 22 is configured and adapted to be undoably arrangeable by the quick-release blade lock 16 in at least one recess 23 having the blade shaft 14 in order to undoably fix at least one blade element 13. As shown in the figures, just one blade element 13 is arrangeable on each individual blade shaft 14 of the blade device 12. In further embodiments (not shown in the figures), it may be appropriate for a plurality and/or multiplicity of blade elements 13 to be arrangeable on a blade shaft 14. In embodiments, the at least one blade shaft 14 is configured and adapted to be rotatable and drivable in both directions. By the quick-release blade lock 16, the blade elements 13 are configured and adapted to be rotatable in both directions of rotation D independently of the fixation used. In embodiments, as shown in the figures, the blade element 13 is configured and adapted as a circular blade.

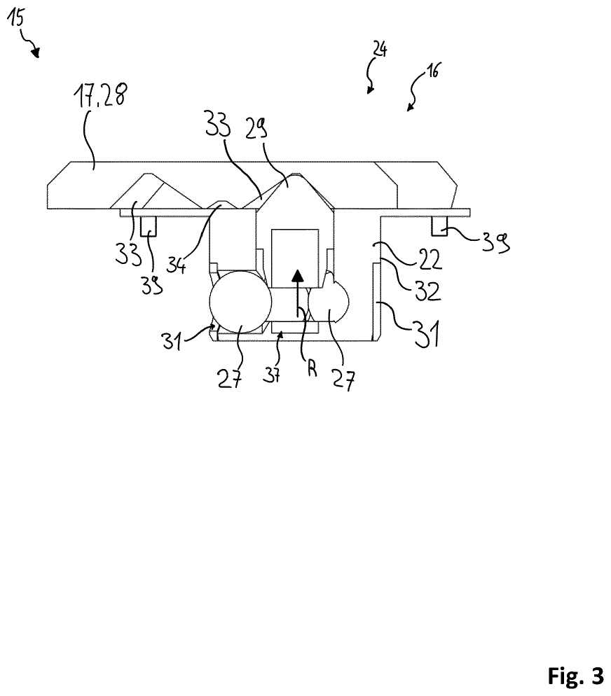

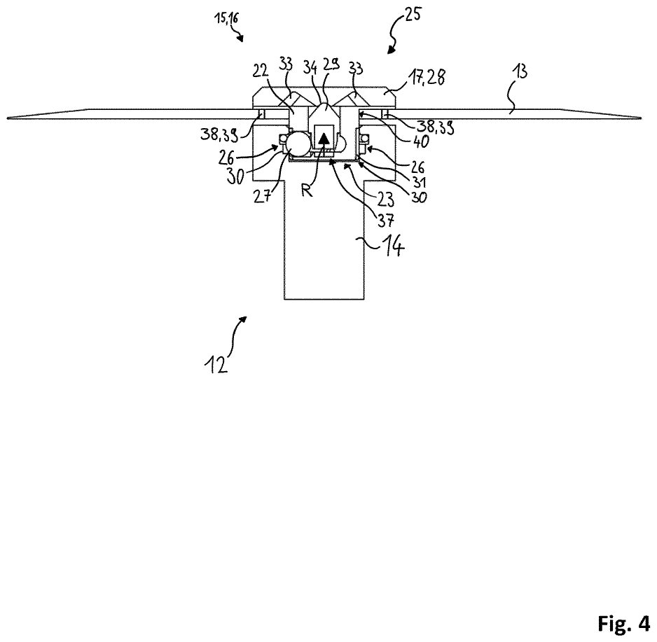

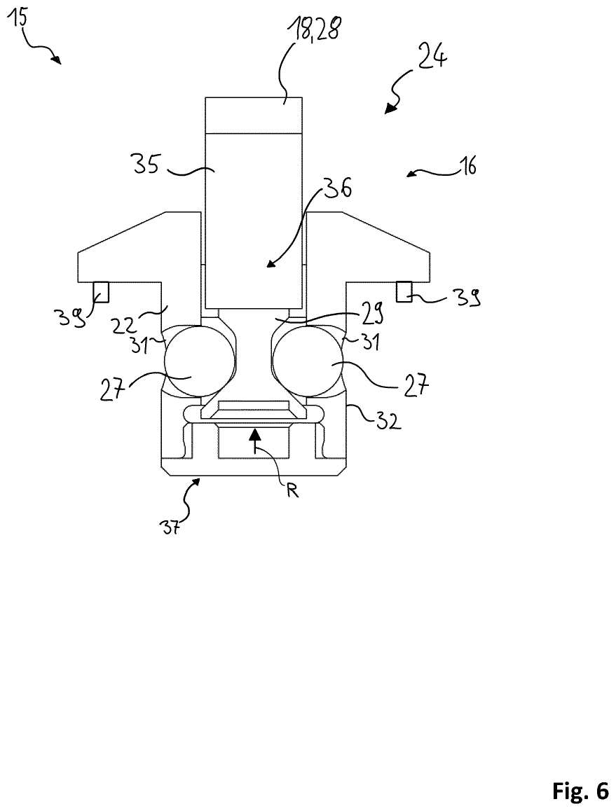

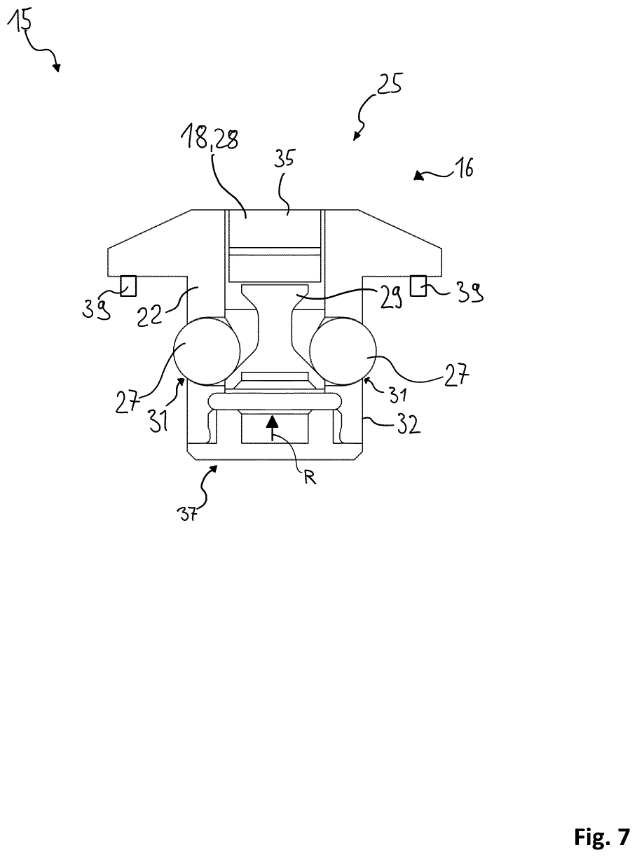

In embodiments shown in FIG. 1 to FIG. 7, the quick-release blade lock 16 is configured and adapted to be modifiable at least between an open position 24 and a closed position 25, wherein, in the closed position 25, the quick-release blade lock 16 fixes the blade element 13 against spontaneously coming undone. FIG. 3, FIG. 5 and FIG. 6 each show the respective quick-release blade locks 16 in an open position 24, while FIG. 1, FIG. 2, FIG. 4 and FIG. 7 each show the quick-release blade locks 16 in the closed position 25. Thanks to the modifiability of the at least one quick-release blade lock 16 from the open position 24 into the closed position 25, the blade element 13 is undoably fixable on the blade shaft 14 and usable cutting the food products 11 as intended. In this way, the quick-release blade lock 16 prevents the blade element 13 from coming undone from the blade shaft 14 in order to configure and adapt reliable cutting. In order to configure and adapt intentional undoing of the blade element 13, the quick-release blade lock 16 is modifiable from the closed position 25 into the open position 24 in order to release the blade element 13 from the blade shaft 14.

Use of the quick-release blade lock 16 in the apparatus 10 according to the present disclosure is shown by way of example in FIG. 3 and FIG. 4 and in FIG. 6 and FIG. 7 by the two positions 24, 25 of the quick-release blade lock 16 being shown. If the apparatus 10 is equipped without a blade element 13 and without an arranged quick-release blade lock 16, the blade shaft 14 is present with its recess 23. The blade base member 22 is arrangeable in the recess 23 in order to undoably fasten the blade element 13 on the blade shaft 14 by the quick-release blade lock 16. In embodiments, the blade element 13 has at least one aperture 40 in the middle that is provided for passage of the quick-release blade lock 16. The aperture 40 is positionable on the blade shaft 14, while the quick-release blade lock 16 passes through the aperture 40 in order to arrange the blade base member 22 in the recess 23 of blade shaft 14 and fasten it accordingly.

In a further embodiment, the quick-release blade lock 16 comprises at least one arresting element 28 and at least one transfer element 29, wherein the at least one arresting element 28 is configured and adapted for modifying the position of the quick-Substitute release blade lock 16 at least between the open position 24 and the closed position 25 by the at least one arresting element 28 being in operative connection with the at least one transfer element 29 in such a way that it configures and adapts a modification in position of the at least one transfer element 29. In particular, the sectional views of FIG. 3 and FIG. 4 and of FIG. 6 and FIG. 7 show an arresting element 28 and a transfer element 29 that are movably configured and adapted to provide a modification in position. To this end, the transfer element 29 is configured and adapted to be axially movable, wherein the modification in position of the quick-release blade lock 16 can be produced by contact of the arresting element 28 against the transfer element 29. FIG. 3 and FIG. 4 each show an embodiment of an arresting element 28 that is positionally movable by a displacement, wherein the arresting element 28 of FIG. 6 and FIG. 7 configures and adapts a modification in position by a lever movement.

An embodiment is distinguished in that the recess 23 of the blade shaft 14 has at least one engagement recess 26 and in that the blade base member 22 comprises at least one engagement element 27 for engagement with the engagement recess 26, wherein, in the closed position 25 of the quick-release blade lock 16, the engagement element 27 is configured and adapted to be in force-fit and/or form-fit engagement with the at least one engagement recess 26 and wherein, in the open position 24 of the quick-release blade lock 16, the at least one engagement element 27 is configured and adapted to be substantially out of engagement with the at least one engagement recess 26. In particular, the sectional view of FIG. 4 shows the respective engagement recesses 26 and engagement elements 27 in relation to one another. In the first exemplary embodiment according to the present disclosure of FIG. 3, the quick-release blade lock 16 is in the open position 24 and in FIG. 1, FIG. 2 and FIG. 4 the quick-release blade lock 16 is arranged in the closed position 25, wherein, as shown in FIG. 3, the at least one engagement element 27 is configured and adapted to be substantially out of engagement and, in FIG. 4, the at least one engagement element 27 is arranged at least in part in the at least one engagement recess 26. In the sectional view of the second exemplary embodiment of FIG. 7, the at least one engagement element 27 is likewise at least in part outside the blade base member 22, in order to be arranged in the at least one engagement recess 26.

In embodiments, the at least one transfer element 29 can be brought into operative connection with the at least one engagement element 27 in such a way that, in the event of a modification in position, the at least one transfer element 29 configures and adapts a force-fit and/or form-fit engagement of the at least one engagement element 27 in the at least one engagement recess 26 or that the at least one transfer element 29 enables release of the at least one engagement element 27 from the at least one engagement recess 26, wherein in particular, in an open position 24 of the quick-release blade lock 16, release of the at least one engagement element 27 out of at least one engagement recess 26 is provided and, in a closed position 25 of the quick-release blade lock 16, engagement of the at least one engagement element 27 with the at least one engagement recess 26 is provided. In particular in the sectional views of FIG. 3 to FIG. 7, the respective modification in position of the at least one transfer element 29 is shown in conjunction with the at least one engagement element 27, wherein in each case engagement or release of the at least one engagement element 27 with/from the engagement recess 26 is provided. In the first exemplary embodiment according to the present disclosure of FIG. 3 and of FIG. 5 and FIG. 6, the at least one engagement element 27 is configured and adapted to be substantially out of engagement with the at least one engagement recess 26. In FIG. 4, the at least one transfer element 29 is at least in part in engagement with the at least one engagement element 27, wherein a force- and/or form-fit connection is configured in order to arrange the at least one blade element 13 on the blade shaft 14 in fixed manner. In the sectional view of the second exemplary embodiment of FIG. 7, the at least one engagement element 27 is likewise at least in part arrangeable in the at least one engagement recess 26 in order to configure and adapt a force-fit and/or form-fit engagement of the at least one engagement element 27 in the at least one engagement recess 26, this being controllable by the modification in position of the transfer element 29. In embodiments, the at least one engagement recess 26 is configured and adapted, in particular circumferentially configured and adapted, on the inner wall 30 of the recess 23 of the blade shaft 14. In embodiments, in the sectional view of FIG. 4, the at least one engagement recess 26 is circumferentially configured and adapted on the inner wall 30 as a single engagement recess 26. In embodiments (not shown in the figures), at least the number of engagement recesses 26 may be provided as correspond to the number of engagement elements 27, in particular if the engagement recess 26 is not configured and adapted as a single circumferential engagement recess 26. Alternatively or additionally, the at least one engagement recess 26 can be configured and adapted for engagement with a plurality of engagement elements 27.

In embodiments, the at least one engagement element 27 and the at least one engagement recess 26 are configured and adapted to correspond to one another at least in portions, in particular such that, in the closed position 25 of the quick-release blade lock 16, a force-locking and/or form-fit connection is provided between the at least one engagement element 27 and the at least one engagement recess 26. The at least one engagement element 27 and the at least one engagement recess 26 are then, as shown in FIG. 4, configured and adapted to correspond to one another at least substantially in portions if the at least one engagement element 27 and the at least one engagement recess 26 substantially correspond dimensionally (positively/negatively) at least in portions. The engagement element 27 is, however, configured and adapted to be at least slightly smaller than the engagement recess 26.

In embodiments, at least two to seven engagement elements 27 are provided, particularly three to five engagement elements 27. In embodiments, the quick-release blade locks 16 of FIG. 1 to FIG. 7 have three engagement elements 27 that are arranged in a star shape along the circumference of the blade base member 22. The star-shaped arrangement ensures that forces are distributed as uniformly as possible. In embodiments, the at least one engagement element 27 is arrangeable within the blade base member 22 such that it is configured and adapted to be movable but captive, as is in particular clarified by FIG. 6 and FIG. 7. FIG. 5 to FIG. 7 each show an engagement element 27 that is arranged internally within the blade base member 22 and is movable at least in part through an aperture 31 in the direction of the outer face 32. In embodiments, the aperture 31 of the outer face 32 is smaller than the at least one engagement element 27 in order to prevent loss, i.e. complete passage through the aperture 31.

In embodiments, the at least one engagement element 27 and/or the at least one engagement recess 26 is at least in part coated with an elastic layer (not shown in detail in the figures) that is selected, for example, from an elastic material such as rubber or silicone. This ensures hygienic and force-locking engagement by the at least one engagement element 27. The elastic layer provides a greater force-locking component, as a result of which, for example, a smaller engagement depth with the at least one engagement recess 26 need be provided. In embodiments, the at least one engagement recess 26 and/or the at least one engagement element 27 has at least one O-ring or thin spring steel in order to configure and adapt an additional engagement component.

In embodiments, the arresting element 28 is connected, in particular captively connected, to the blade base member 22. The arresting element 28 is for example connected to the blade base member 22 by an articulated connection, as shown in FIG. 5 to FIG. 7. As shown in the first embodiment of FIG. 3 and FIG. 4, the arresting element 28 is configured and adapted as a sliding element 17 slidable at least between an open position 24 and a closed position 25, wherein, on displacement of the sliding element 17, at least a change between the open position 24 and the closed position 25 is configured and adapted. In embodiments, the sliding element 17 comprises at least two sliding recesses 33, 34 that are configured and adapted to engage at least in part with the transfer element 29, wherein at least one of the sliding recesses 34 configures and adapts a smaller engagement with the transfer element 29. The sliding element of FIG. 1 to FIG. 4 has three sliding recesses 33, 34, wherein two of the sliding recesses 33 each enable substantially identical engagement with the transfer element 29 and wherein the sliding recess 34 that enables a smaller engagement with the transfer element 29 and to this end has a smaller recess is arranged between the sliding recesses 33. In embodiments, the sliding element 17 of FIG. 1 to FIG. 4 is in each case configured and adapted to be slidable in both directions, wherein, in the event of the transfer element 29 being arranged in the larger sliding recesses 33, release of the engagement element 27 from the engagement recess 26 is enabled in each case.

In the embodiment of FIG. 6 and FIG. 7, the arresting element 28 is configured and adapted as a lever element 18 movable at least between an open position 24 and a closed position 25, wherein, on actuation of the lever element 18, at least a change between the open position 24 and the closed position 25 is configured and adapted. In embodiments, the lever element 18 is configured and adapted as an eccentric lever 35, wherein, in the closed position 25, an actuating portion 36 of the eccentric lever 35 can be brought into operative connection with the transfer element 29, and wherein, in the open position 24, the actuating portion 36 of the eccentric lever 35 releases the transfer element 29. The transfer element 29 is in particular releasable such that the force- and/or form-fit connection between the at least one engagement element 27 and the at least one engagement recess 26 is reversible.

In a further embodiment, the blade device 12 comprises at least one restoring element 37 that is configured and adapted to exert a restoring force R on the transfer element 29 that moves the latter into or in the direction of the quick-release blade lock 16. In embodiments, the restoring force R is providable by a spring element (not shown in detail in the figures) and/or by a magnet unit. FIG. 3 and FIG. 4 as well as FIG. 6 and FIG. 7 each show a fastening mechanism 15 with a restoring element 37. In embodiments, restoring element that produces the restoring force R is arranged internally within the blade base member 22. The restoring force R causes the transfer element 29 to be axially outwardly displaceable, in particular in the course of the blade shaft 14. When, for example, the quick-release blade lock 16 is actuated and transferred from the open position 24 into the closed position 25, the transfer element 29 is movable against the restoring force R. In the event of a change in state of the quick-release blade lock 16 and transfer from the closed position 25 into the open position 24, the transfer element 29 is displaced with the restoring force R in the direction of the outside of the blade device 12.

In further embodiments, the blade element 13 comprises at least one fixation recess 38 and the blade device 12 comprises at least one fixation element 39 that corresponds at least in portions to the at least one fixation recess 38, whereby the blade element 13 is fixedly arrangeable on the blade device 12 with a form fit and non-rotatably relative to the blade shaft 14 by the quick-release blade lock 16. In FIG. 3, FIG. 4, FIG. 6 and FIG. 7, the fastening mechanism 15 in each case has the fixation elements 39. In further embodiments (not shown in the figures), the blade shaft 14 comprises at least one fixation recess 38 and/or at least one fixation element 39.

A further embodiment provides an apparatus for processing food products 11, in particular for processing carcasses 41. The further apparatus for processing food products 11 comprises a conveying device 19 that may have a conveying unit and the latter is configured and adapted to convey the food products 11 in a conveying direction T along a conveying route 21, which is in other words a conveying path. The food products 11 are configured and adapted by at least one dressing station 42 for processing the carcass 41, namely an apparatus 10 for detaching and/or cutting meat or carcass components from a carcass 41 or parts thereof, which apparatus comprises at least one blade device 12 according to the present disclosure with a quick-release blade lock 16. Such apparatuses are particularly suitable for processing slaughtered and eviscerated fish 41, although for example poultry carcasses or the like can likewise be dressed by such apparatuses, wherein adaptations, for example to the conveying device 19 or the blade device 12, may optionally have to be made.

1. An apparatus for cutting food products comprising:
at least one blade device for undoable arrangement of a blade element;
at least one rotatably mounted blade shaft that is configured to receive the blade device; and
at least one drive element that is configured to drive the blade shaft in a direction of rotation,
wherein the blade device comprises a fastening mechanism for undoably fastening the blade element on the blade shaft, wherein the fastening mechanism is configured as a quick-release blade lock.

2. The apparatus according to claim 1, wherein the blade device comprises a blade base member, wherein the blade base member is configured to be undoably arrangeable by the quick-release blade lock in at least one recess having the blade shaft in order to undoably fix the at least one blade element.

3. The apparatus according to claim 2, wherein the quick-release blade lock is configured to be modifiable at least between an open position and a closed position, wherein, in the closed position, the quick-release blade lock fixes the blade element against spontaneously coming undone.

4. The apparatus according to claim 3, wherein the at least one recess of the blade shaft has at least one engagement recess and the blade base member comprises at least one engagement element for engagement with the at least one engagement recess, wherein, in the closed position of the quick-release blade lock, the at least one engagement element is configured to be in force-fit and/or form-fit engagement with the at least one engagement recess and wherein, in the open position of the quick-release blade lock, the at least one engagement element is configured to be substantially out of engagement with the at least one engagement recess.

5. The apparatus according to claim 4, wherein the quick-release blade lock comprises at least one arresting element and at least one transfer element, wherein the at least one arresting element is configured for modifying a position of the quick-release blade lock at least between the open position and the closed position by the at least one arresting element being in operative connection with the at least one transfer element in such a way that it configures a modification in position of the at least one transfer element.

6. The apparatus according to claim 5, wherein the at least one transfer element is configured to be brought into operative connection with the least one engagement element in such a way that, in a case of a modification in position, the at least one transfer element configures a force-fit and/or form-fit engagement of the at least one engagement element in the at least one engagement recess or that the at least one transfer element enables release of the at least one engagement element from the at least one engagement recess, wherein, in the open position of the quick-release blade lock, release of the at least one engagement element out of the at least one engagement recess is provided and, in the closed position of the quick-release blade lock, engagement of the at least one engagement element with the at least one engagement recess is provided.

7. The apparatus according to claim 4, wherein the at least one engagement recess is configured on an inner wall of the recess of the blade shaft.

8. The apparatus according to claim 4, wherein two to seven engagement elements are provided.

9. The apparatus according to claim 4, wherein the at least one engagement element and the at least one engagement recess are configured to correspond to one another at least in portions such that, in the closed position of the quick-release blade lock, a force-locking and/or form-fit connection is provided between the at least one engagement element and the at least one engagement recess.

10. The apparatus according to claim 4, wherein the at least one engagement element is arrangeable within the blade base member such that the at least one engagement element is configured to be movable but captive.

11. The apparatus according to claim 5, wherein the arresting element is connected to the blade base member.

12. The apparatus according to claim 5, wherein the arresting element is configured as a sliding element slidable at least between the open position and the closed position, wherein, on displacement of the sliding element, at least a change between the open position and the closed position is configured.

13. The apparatus according to claim 12, wherein the sliding element comprises at least two sliding recesses that are configured to engage at least in part with the transfer element, wherein at least one of the at least two sliding recesses configures a smaller engagement with the transfer element.

14. The apparatus according to claim 5, wherein the arresting element is configured as a lever element movable at least between the open position and the closed position, wherein, on actuation of the lever element, at least a change between the open position and the closed position is configured.

15. The apparatus according to claim 14, wherein the lever element is configured as an eccentric lever, wherein, in the closed position, an actuating portion of the eccentric lever is configured to be brought into operative connection with the transfer element, and wherein, in the open position, the actuating portion of the eccentric lever releases the transfer element.

16. The apparatus according to claim 5, wherein the blade device comprises at least one restoring element that is configured to exert a restoring force on the transfer element that moves the transfer element into or in a direction of the quick-release blade lock.

17. The apparatus according to claim 1, wherein the blade element comprises at least one fixation recess and the blade device comprises at least one fixation element that corresponds at least in portions to the at least one fixation recess, wherein the blade element is fixedly arrangeable on the blade device with a form fit and non-rotatably relative to the blade shaft by the quick-release blade lock.

18. An apparatus for processing food products the apparatus comprising:
at least one dressing station configured to process the food products to detach and/or cut meat or carcass components from the food products or parts thereof; and
a conveying unit configured to convey the food products in a conveying direction along a conveying path through the at least one dressing station,
wherein the at least one dressing station comprises:
at least one blade device for undoable arrangement of a blade element;
at least one rotatably mounted blade shaft that is configured to receive the blade device; and
at least one drive element that is configured to drive the blade shaft in a direction of rotation,
wherein the blade device comprises a fastening mechanism for undoably fastening the blade element on the blade shaft, wherein the fastening mechanism is configured as a quick-release blade lock.

19. A fastening mechanism for undoably fastening a blade element on a blade shaft, wherein the fastening mechanism is configured as a quick-release blade lock (16) according to claim 1.
